(19) United States
(12) Patent Application Publication
(10) Pub. No.: US 2024/0363922 A1
(43) Pub. Date: Oct. 31, 2024

(54) THERMAL MANAGEMENT AND VENTING SYSTEMS FOR TRACTION BATTERY PACKS

(71) Applicant: FORD GLOBAL TECHNOLOGIES, LLC, Dearborn, MI (US)

(72) Inventor: Xiaogang Zhang, Novi, MI (US)

(21) Appl. No.: 18/306,436

(22) Filed: Apr. 25, 2023

(51) Int. Cl. H01M 10/6568; B60L 50/64; H01M 10/613; H01M 10/625; H01M 50/209

(52) U.S. Cl. CPC H01M 10/6568; B60L 50/64; H01M 10/613; H01M 10/625; H01M 50/209; H01M 2220/20

(57) ABSTRACT

Thermal management and venting systems are provided for traction battery packs. An exemplary thermal management and venting system may include a vent manifold and a main coolant passage extending through the vent manifold. The vent manifold may be configured to expel a battery vent byproduct from the traction battery pack during a battery thermal event, and the main coolant passage may be configured to communicate a coolant for thermally managing a battery array of the traction battery pack. A heat exchanger of the thermal management and venting system may be configured to facilitate heat transfer between the battery vent byproduct and the coolant prior to expelling the battery vent byproduct from the traction battery pack.

### TECHNICAL FIELD

This disclosure relates generally to electrified vehicle traction battery packs, and more particularly to thermal management and venting systems for traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first battery array, a second battery array, a channel extending between the first battery array and the second battery array, a vent manifold positioned within the channel, and a main coolant passage extending through the vent manifold.

In a further non-limiting embodiment of the foregoing traction battery pack, the first battery array is part of a first row of battery arrays, and the second battery array is part of a second row of battery arrays.

In a further non-limiting embodiment of either of the foregoing traction battery packs, a first runner fluidly connects the first battery array to the vent manifold, and a second runner fluidly connects the second battery array to the vent manifold.

In a further non-limiting embodiment of any of the foregoing traction battery packs, a first check valve is disposed within the first runner, and a second check valve is disposed within the second runner.

In a further non-limiting embodiment of any of the foregoing traction battery packs, the vent manifold and the main coolant passage are concentrically arranged within the channel.

In a further non-limiting embodiment of any of the foregoing traction battery packs, a first secondary coolant passage and a second secondary coolant passage are fluidly connected to the main coolant passage.

In a further non-limiting embodiment of any of the foregoing traction battery packs, the first secondary coolant passage extends between the first battery array and a third battery array, and the second secondary coolant passage extends between the first battery array and a fourth battery array.

In a further non-limiting embodiment of any of the foregoing traction battery packs, the vent manifold is configured to expel a battery vent byproduct from the traction battery pack during a battery thermal event, and the main coolant passage is configured to communicate a coolant for thermally managing the first battery array and the second battery array.

In a further non-limiting embodiment of any of the foregoing traction battery packs, a heat exchanger is fluidly connected to the vent manifold and the main coolant passage.

In a further non-limiting embodiment of any of the foregoing traction battery packs, the heat exchanger is configured to cool the battery vent byproduct with the coolant prior to discharging the battery vent byproduct from the traction battery pack.

In a further non-limiting embodiment of any of the foregoing traction battery packs, a first fluid that is communicated inside the main coolant passage is fluidly isolated from a second fluid that is communicated inside the vent manifold.

In a further non-limiting embodiment of any of the foregoing traction battery packs, the first battery array or the second battery array is positioned adjacent to a heat exchanger plate.

A traction battery pack according to another exemplary aspect of the present disclosure includes, among other things, a first row of battery arrays, a second row of battery arrays, a vent manifold extending between the first row of battery arrays and the second row of battery arrays and configured to communicate a battery vent byproduct, a main coolant passage configured to communicate a coolant, and a heat exchanger fluidly connected to the vent manifold and the main coolant passage and configured to facilitate a heat transfer between the battery vent byproduct and the coolant.

In a further non-limiting embodiment of the foregoing traction battery pack, the heat exchanger is disposed inside an enclosure assembly of the traction battery pack.

In a further non-limiting embodiment of either of the foregoing traction battery packs, the heat exchanger is disposed outside of an enclosure assembly of the traction battery pack.

In a further non-limiting embodiment of any of the foregoing traction battery packs, the heat exchanger is configured to facilitate the heat transfer prior to discharging the battery vent byproduct from the traction battery pack.

In a further non-limiting embodiment of any of the foregoing traction battery packs, the heat exchanger is configured to cool the battery vent byproduct with the coolant prior to discharging the battery vent byproduct from the traction battery pack.

In a further non-limiting embodiment of any of the foregoing traction battery packs, the vent manifold and the main coolant passage are concentrically arranged within a channel that extends between the first row of battery arrays and the second row of battery arrays.

In a further non-limiting embodiment of any of the foregoing traction battery packs, a first runner fluidly connects a first battery array of the first row of battery arrays to the vent manifold, and a second runner fluidly connects a second battery array of the second row of battery arrays to the vent manifold.

In a further non-limiting embodiment of any of the foregoing traction battery packs, a first secondary coolant passage and a second secondary coolant passage are fluidly connected to the main coolant passage. The first secondary coolant passage extends between a first battery array and a second battery array of the first row of battery arrays, and the second secondary coolant passage extends between a third battery array and a fourth battery array of the second row of battery arrays.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack that includes a thermal management and venting system.

FIG. 3 illustrates another exemplary traction battery pack that includes a thermal management and venting system.

FIG. 4 schematically illustrates operation of the thermal management and venting system of FIG. 2 during a battery thermal event.

FIG. 5 is a cross-sectional view through section 5-5 of FIG. 2.

### DETAILED DESCRIPTION

This disclosure details thermal management and venting systems for traction battery packs. An exemplary thermal management and venting system may include a vent manifold and a main coolant passage extending through the vent manifold. The vent manifold may be configured to expel a battery vent byproduct from the traction battery pack during a battery thermal event, and the main coolant passage may be configured to communicate a coolant for thermally managing a battery array of the traction battery pack. A heat exchanger of the thermal management and venting system may be configured to facilitate heat transfer between the battery vent byproduct and the coolant prior to expelling the battery vent byproduct from the traction battery pack. These and other features are discussed in greater detail in the following paragraphs of this detailed description.

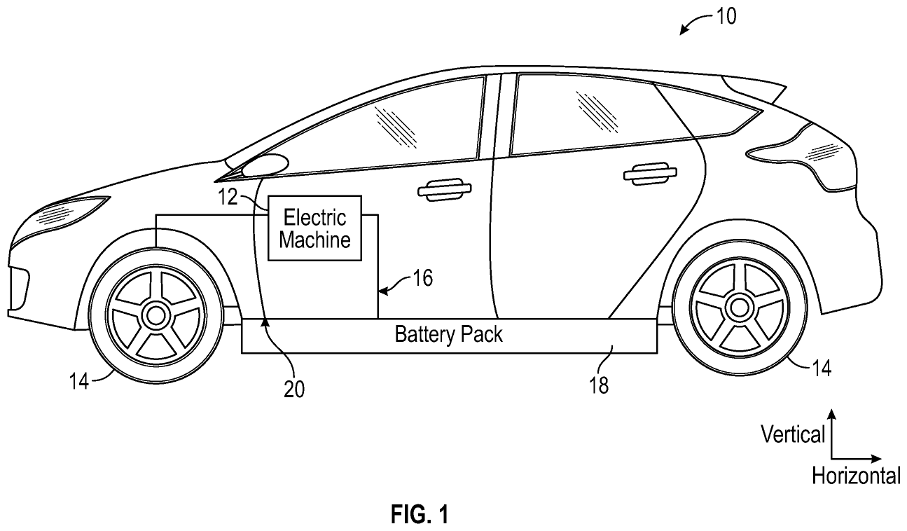

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

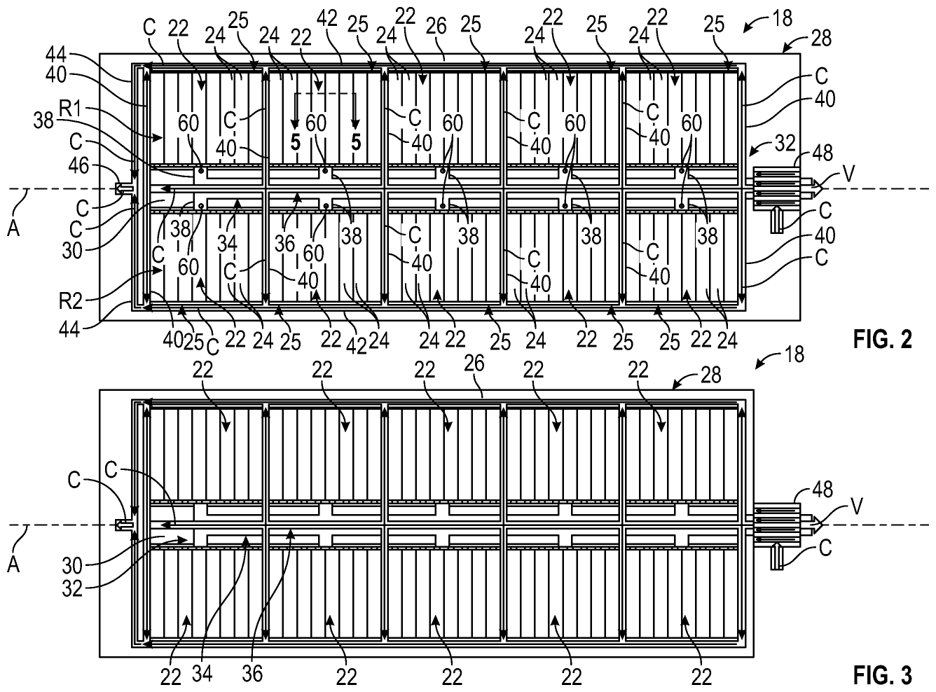

FIG. 2 illustrates additional details associated with the traction battery pack 18 of the electrified vehicle 10. The traction battery pack 18 may include a plurality of battery arrays 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The battery cells 24 may be supported by an array support structure 25, which may include a plurality of plate-like structures (e.g., top plate, bottom plate, sides plates, end plates) that surround the battery cells 24 of each battery array 22. The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 may be arranged in multiple rows inside the traction battery pack 18. In an embodiment, the battery arrays 22 are arranged in a first row R1 and a second row R2 that is laterally adjacent to the first row R1. The first row R1 and the second row R2 may each include five battery arrays 22 (for a total of ten battery arrays 22), and each battery array 22 may include eight battery cells 24 (for a total of eighty battery cells 24). However, other configurations are possible, and therefore the traction battery pack 18 could include a greater or fewer number of rows, battery arrays, and battery cells within the scope of this disclosure.

The battery arrays 22 and various other battery internal components (e.g., bussed electrical center, battery electric control module, wiring, connectors, etc.) may be housed within an interior area 26 of an enclosure assembly 28. Although shown schematically, the enclosure assembly 28 could include a single-piece design or multi-piece design (e.g., enclosure cover and enclosure tray that are joined together to establish the interior area 26). The size, shape, and overall configuration of the enclosure assembly 28 is not intended to limit this disclosure. In an embodiment, the enclosure assembly 28 provides a sealed enclosure around the battery arrays 22 and other battery internal components of the traction battery pack 18.

Each battery array 22 may be completely separated from the other battery arrays 22 of the traction battery pack 18. For example, the battery arrays 22 may be spaced apart from one another within each of the first row R1 and second row R2, and a channel 30 may extend between the first row R1 and the second row R2 for separating the battery arrays 22 of the first row R1 from the battery arrays 22 of the second row R2. The channel 30 may extend along a central longitudinal axis A of the traction battery pack 18. In an embodiment, the channel 30 bisects the interior area 26 of the enclosure assembly 28.

The traction battery pack 18 may additionally include a thermal management and venting system 32. As further explained below, the thermal management and venting system 32 may be configured to thermally manage the battery arrays 22 and further to manage battery vent byproducts V during battery thermal events. A battery thermal event may occur, for example, during over-charging conditions, over-discharging conditions, or other conditions and can cause one or more of the battery cells 24 to expel the battery vent byproducts V, which may include gases, effluent particles, and/or other vent byproducts.

The thermal management and venting system 32 may include a vent manifold 34 and a main coolant passage 36. The vent manifold 34 may be arranged within the channel 30 and is therefore disposed axially between the first row R1 of battery arrays 22 and the second row R2 of battery arrays 22. The vent manifold 34 may be configured to communicate battery vent byproducts V from one or more of the battery arrays 22 toward a position where the battery vent byproducts V can be expelled from the traction battery pack 18 during battery thermal events.

Each battery array 22 may be fluidly connected to the vent manifold 34 by a runner 38. Each runner 38 may include a check valve 60 configured for preventing the battery vent byproducts V from flowing back to the battery array 22 once inside the runner 38.

The main coolant passage 36 may extend through the vent manifold 34. The main coolant passage 36 and the vent manifold 34 may establish fluidly isolated concentric flow passages that extend along the central longitudinal axis A. The main coolant passage 36 may be configured to communicate a coolant C for managing the heat generated by the battery cells 24 of the battery arrays 22 during operation of the traction battery pack 18. In an embodiment, the coolant C is a conventional type of coolant mixture such as water mixed with ethylene glycol. However, other coolants, including gases, are also contemplated within the scope of this disclosure.

A plurality of secondary coolant passages 40 may be fluidly connected to the main coolant passage 36. One secondary coolant passage 40 may extend between each adjacent pair of battery arrays 22 of the first row R1 and the second row R2. The secondary cooling passages 40 may extend along longitudinal axes that are transverse to the central longitudinal axis A.

The coolant C may be communicated through the main coolant passage 36 before being separated into the multiple secondary coolant passages 40. The coolant C may pick up heat from the battery arrays 22 as it flows through the secondary coolant passages 40, thereby carrying away excessive heat and stabilizing the temperatures of the battery cells 24. The coolant C may then merge into return coolant passages 42 disposed along the lengths of the first row R1 and the second row R2 before merging again within egress coolant passages 44 that are fluidly connected to a coolant outlet 46 for expelling the coolant C from the traction battery pack 18.

The thermal management and venting system 32 may additionally include a heat exchanger 48. The heat exchanger 48 may be a two-path heat exchanger that is fluidly connected to both the vent manifold 34 and the main coolant passage 36. Battery vent byproducts V may be communicated through a first path of the heat exchanger 48, and the coolant C may be communicated through a second path of the heat exchanger 48. The battery vent byproducts V and the coolant C may therefore exchange heat with one another within the heat exchanger 48 during a battery thermal event.

In an embodiment, the heat exchanger 48 is substantially positioned inside the enclosure assembly 28 of the traction battery pack 18 and is therefore packaged within the interior area 26 (see FIG. 2). In another embodiment, the heat exchanger 48 is substantially positioned outside the enclosure assembly 28 of the traction battery pack 18 and is therefore remote from the interior area 26 (see FIG. 3).

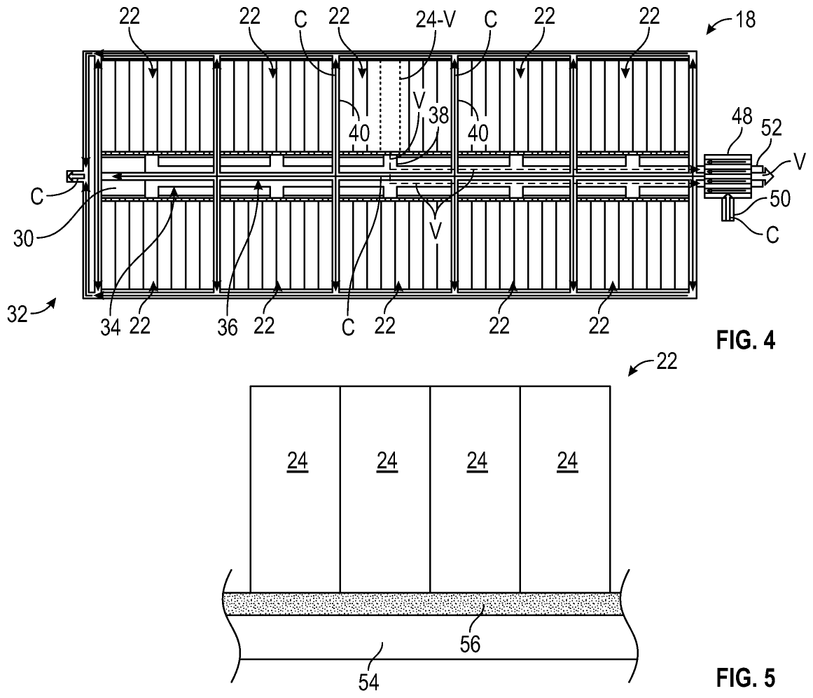

FIG. 4, with continued reference to FIGS. 1-3, schematically illustrates an exemplary operation of the thermal management and venting system 32 of the traction battery pack 18 during a battery thermal event. When the battery thermal event occurs, one or more of the battery cells 24 may vent battery vent byproducts V into the vent manifold 34. In the illustrated embodiment, the battery cell that has vented to release battery vent byproducts V is indicated by reference numeral 24-V. The battery vent byproducts V may be communicated into the runner 38 of the battery array 22 that includes the battery cell 24-V and then into the vent manifold 34 where it can flow in a direction toward the heat exchanger 48.

The battery vent byproducts V may exchange heat with the coolant C within the heat exchanger 48. The coolant C may enter the heat exchanger 48 through a coolant inlet 50. The battery vent byproduct V can therefore be cooled by the coolant C prior to being expelled from the traction battery pack 18 through a vent outlet 52. Coolant C exiting the heat exchanger 48 may enter the main coolant passage 36 and then the secondary coolant passages 40 for cooling down the battery arrays 22, thereby substantially preventing array-to-array thermal propagation during the battery thermal event.

Referring now to FIG. 5, with continued reference to FIGS. 2-4, the thermal management and venting system 32 may additionally include one or more heat exchanger plates 54. The heat exchanger plate 54 may be configured as a cold plate for further conducting heat out of the battery cells 24. In an embodiment, each battery array 22 may includes its own dedicated heat exchanger plate 54. In another embodiment, two or more battery arrays 22 may share a common heat exchanger plate 54.

A thermal interface material 56 may be provided between the battery cells 24 of the battery array 22 and the heat exchanger plate 54. The thermal interface material 56 may be configured to fixedly secure the battery cells 24 in place relative to the heat exchanger plate 54. In an embodiment, bottom-facing surfaces of the battery cells 24 are in direct contact with the thermal interface material 56. However, other configurations are contemplated within the scope of this disclosure.

The thermal interface material 56 may be further configured to maintain thermal contact between the battery cells 24 and the heat exchanger plate 54, thereby facilitating thermal conductivity between these neighboring components during heat transfer events. Heat conducted from the battery cells 24 to the heat exchanger plate 54 may then be carried away from the battery cells 24, such as by an additional coolant or portion of the coolant C that may be circulated inside the heat exchanger plate 54.

The exemplary traction battery packs of this disclosure integrate vent gas management and battery thermal management into a simple, compact design. Arranging the features of a vent manifold and a main coolant passage concentrically provides a space efficient design that facilitates increased heat transfer from vent gas-to-coolant during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first battery array;
a second battery array;
a channel extending between the first battery array and the second battery array;
a vent manifold positioned within the channel; and
a main coolant passage extending through the vent manifold.

2. The traction battery pack as recited in claim 1, wherein the first battery array is part of a first row of battery arrays, and the second battery array is part of a second row of battery arrays.

3. The traction battery pack as recited in claim 1, comprising a first runner that fluidly connects the first battery array to the vent manifold, and a second runner that fluidly connects the second battery array to the vent manifold.

4. The traction battery pack as recited in claim 3, comprising a first a check valve disposed within the first runner, and a second check valve disposed within the second runner.

5. The traction battery pack as recited in claim 1, wherein the vent manifold and the main coolant passage are concentrically arranged within the channel.

6. The traction battery pack as recited in claim 1, comprising a first secondary coolant passage and a second secondary coolant passage fluidly connected to the main coolant passage.

7. The traction battery pack as recited in claim 6, wherein the first secondary coolant passage extends between the first battery array and a third battery array, and the second secondary coolant passage extends between the first battery array and a fourth battery array.

8. The traction battery pack as recited in claim 1, wherein the vent manifold is configured to expel a battery vent byproduct from the traction battery pack during a battery thermal event, and the main coolant passage is configured to communicate a coolant for thermally managing the first battery array and the second battery array.

9. The traction battery pack as recited in claim 8, comprising a heat exchanger that is fluidly connected to the vent manifold and the main coolant passage.

10. The traction battery pack as recited in claim 9, wherein the heat exchanger is configured to cool the battery vent byproduct with the coolant prior to discharging the battery vent byproduct from the traction battery pack.

11. The traction battery pack as recited in claim 1, wherein a first fluid communicated inside the main coolant passage is fluidly isolated from a second fluid communicated inside the vent manifold.

12. The traction battery pack as recited in claim 1, wherein the first battery array or the second battery array is positioned adjacent to a heat exchanger plate.

13. A traction battery pack, comprising:
a first row of battery arrays;
a second row of battery arrays;
a vent manifold extending between the first row of battery arrays and the second row of battery arrays and configured to communicate a battery vent byproduct;
a main coolant passage configured to communicate a coolant; and
a heat exchanger fluidly connected to the vent manifold and the main coolant passage and configured to facilitate a heat transfer between the battery vent byproduct and the coolant.

14. The traction battery pack as recited in claim 13, wherein the heat exchanger is disposed inside an enclosure assembly of the traction battery pack.

15. The traction battery pack as recited in claim 13, wherein the heat exchanger is disposed outside of an enclosure assembly of the traction battery pack.

16. The traction battery pack as recited in claim 13, wherein the heat exchanger is configured to facilitate the heat transfer prior to discharging the battery vent byproduct from the traction battery pack.

17. The traction battery pack as recited in claim 13, wherein the heat exchanger is configured to cool the battery vent byproduct with the coolant prior to discharging the battery vent byproduct from the traction battery pack.

18. The traction battery pack as recited in claim 13, wherein the vent manifold and the main coolant passage are concentrically arranged within a channel that extends between the first row of battery arrays and the second row of battery arrays.

19. The traction battery pack as recited in claim 13, comprising a first runner that fluidly connects a first battery array of the first row of battery arrays to the vent manifold, and a second runner that fluidly connects a second battery array of the second row of battery arrays to the vent manifold.

20. The traction battery pack as recited in claim 13, comprising a first secondary coolant passage and a second secondary coolant passage fluidly connected to the main coolant passage, wherein the first secondary coolant passage extends between a first battery array and a second battery array of the first row of battery arrays, and the second secondary coolant passage extends between a third battery array and a fourth battery array of the second row of battery arrays.
